(19) United States
(12) Patent Application Publication
(10) Pub. No.: US 2004/0099145 A1
(43) Pub. Date: May 27, 2004

(54) Orifice modifier

(75) Inventors: Craig Luther Evans, Green Bay, WI (US); Jeffrey Allan Ehlen, Sobieski, WI (US); James Clarence Manteufel, Green Bay, WI (US)

Correspondence Address: UNILEVER, PATENT DEPARTMENT, 45 RIVER ROAD, EDGEWATER, NJ, 07020, US

(73) Assignee: Good Humor-Breyers Ice Cream

(21) Appl. No.: 10/305,840

(22) Filed: Nov. 26, 2002

(51) Int. Cl. A23L 1/00

(52) U.S. Cl. 99/348

(57) ABSTRACT

An orifice modifier which can be added to a frozen confection-dispensing outlet and which can impart, ideally without human intervention, a desired shape to the dispensed product. In a preferred embodiment, the orifice modifier is, or includes, a disk which imposes a shape on the dispensing orifice whereby to produce a product with a desirable pattern. In a particularly preferred embodiment, a mechanism is provided for moving the disk or other orifice modifier while the product is being dispensed. It has been found that if the disk is, for example, rotated during dispensing of the product, an especially esthetically pleasing pattern is formed in the emerging ice cream. Such patterns can be captured for the final product by refrigeration.

### BACKGROUND OF THE INVENTION

Ice cream and other frozen confections have long been favored dessert and snack foods among consumers. Although largely considered indulgence foods, they often may provide valuable nutrients, e.g., calcium, as well. Ice cream sandwiches are a popular vehicle for serving and selling frozen confections. Typically the products comprise ice cream sandwiched between two wafers.

Frozen confection manufacturers often seek to improve their products by providing additional features to attract consumers. While it is believed that ice cream sandwiches are appreciated largely for their organoleptic properties, some manufacturers have differentiated their products by changes in their appearance.

Silhouette Brands Inc. of New York, N.Y. sells the Silhouette® low fat ice cream sandwich product called “[t]he Skinny Cow.” The Skinny Cow includes a braided low fat ice cream design which is visible along the periphery of the sandwich.

Dispensers of soft ice cream products, such as ice cream cones, are well known for their ability to dispense their products by hand from machines in a way such that different patterns of ice cream on the cone can be made.

Various patents disclose methods of dispensing ice cream and/or ice cream sandwiches or methods for shaping a confectionery product. These include Price et al. U.S. Pat. No. 4,612,852, Kennedy et al. U.S. Pat. No. 5,493,957, Grenier U.S. Pat. No. 4,793,279, Tucker et al. U.S. Pat. No. 6,326,046 and Beer U.S. Pat. No. 4,828,854.

It would be desirable to provide an automated mechanism for imparting to ice cream and other frozen confections, especially to ice cream sandwiches, a braided or other design.

### SUMMARY OF THE INVENTION

The present invention is directed to an orifice modifier which can be added to a frozen confection-dispensing outlet and which can impart, ideally without human intervention, a desired shape to the dispensed product. In a preferred embodiment, the orifice modifier is, or includes, a disk which imposes a shape on the dispensing orifice whereby to produce a product with a desirable pattern. In a particularly preferred embodiment, a mechanism is provided for moving the disk or other orifice modifier while the product is being dispensed. It has been found that if the disk is, for example, rotated during dispensing of the product, an especially esthetically pleasing pattern is formed in the emerging ice cream. Such patterns can be captured for the final product by refrigeration.

The orifice modifier of the invention is ideally attached to and is otherwise associated with the dispensing end of an extruder. For example, an adapter which includes the orifice modifier in fluid communication with the dispensing opening of the extruder may be used to attach to the dispensing end of the extruder.

The orifice of the orifice modifier may be provided with a variety of patterns for imparting shapes to the frozen confection. Typically, the orifice of the orifice modifier will have a different shape that the dispensing orifice of the extruder. Most preferably, the orifice modifier takes the form of a disk having a continuous periphery and one or more openings (orifices) in the center. Generally the openings will be other than mere circles, whereby to impart a special shape to the confection. Along the periphery of the opening may be a variety of patterns such as spikes, notches and triangles, which will assist in imparting the design to the frozen confection or other viscous liquid. In its simplest form, the orifice of the orifice modifier can be a simple geometric shape, such as a circle, ellipse, square, rectangle or triangle. More preferably, the orifice of the orifice modifier is more complicated, for example, a geometric shape, such as a circle, having inwardly extending projecting parts, such as prongs, tines, triangles, spurs, teeth, tongues, etc. Preferably, a plurality of points of the circumference of the orifice of the orifice modifier will fall along the circumference of an imaginary geometric shape, especially that of a circle. More preferably, such plurality of points fall along the circumference at regular intervals, e.g., at least 4, preferably at least 8, more preferably at least 16 or at least 32 separate points of intersection of the outer circumference of the orifice with the circle or other imaginary geometric shape. Where the orifice modifier is a disk, preferably the center of the geometric shape coincides with the center of the disk.

Preferably from 10% to at least 10%, especially at least 40%, more preferably a least 60%, and most preferably, at least 85% of the length of the circumference of the opening in the orifice modifier is not in the shape of an arc or arcs. Preferably at least 10% of the circumference of the opening in the orifice modifier is in the shape of an arc. Also preferably, at least 10%, especially at least 40%, more preferably a least 60%, and most preferably, at least 85% of the length of the circumference of the opening in the orifice modifier does not comprise the arc or arcs of the same circle.

The invention is also directed to a method of dispensing a viscous product, especially a frozen confection, by urging the product through an orifice modifier which imposes a pattern on the product. Preferably, the orifice modifier is an adapter which may be attached, using an adapter housing permanently or temporarily, to the dispensing orifice. Most preferably, the orifice modifier is subjected to a rotating or other movement during dispensing of the product to create the pattern in the product.

While the invention finds particular use in dispensing of ice cream and other frozen confections, it is anticipated that it will also find use in the dispensing of other viscous products.

For a more complete understanding of the above and other features and advantages of the invention, reference should be made to the following description of the preferred embodiment.

### BRIEF DESCRIPTION OF THE DRAWINGS

FIG. 1 is a front elevational view of an apparatus according to the invention.

FIG. 2 is a cross sectional view along the lines of 2-2 of the apparatus of FIG. 1.

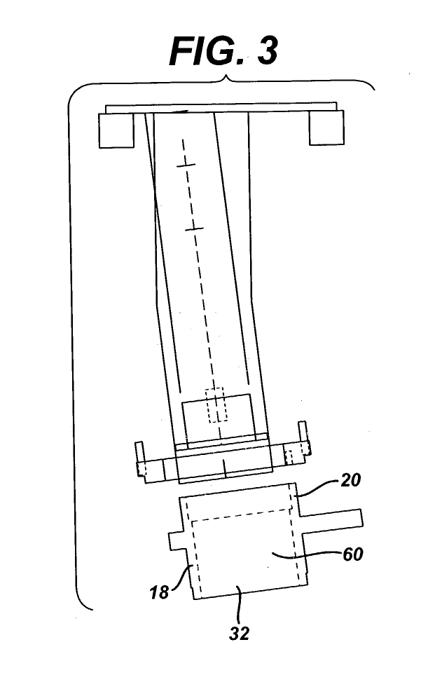

FIG. 3 is a side view of the apparatus of the invention in partial disassembly.

FIGS. 4a-f, 5 and 6 are top plan views of various cutting discs according to the invention.

FIG. 7 is a perspective view of a low/no fat ice cream sandwich made in accordance with the invention.

FIG. 8 is an enlarged side elevation showing a portion of the apparatus according to the invention.

### DETAILED DESCRIPTION OF THE INVENTION

The invention may be employed in the preparation of various frozen confections, especially so called ice-cream sandwiches wherein a frozen confection is sandwiched between two wafers. Machines are available from various vendors to produce ice-cream sandwiches. These so called “cookie sandwich machines” are available from vendors such as Osgood Industries, Inc. of Oldsmar Fla., Norse Dairy Systems of Columbus, Ohio, GRAM Equipment of Tampa Fla., and Tetra Pak Hoyer of Lake Geneva, Wis.

Dispensing of the frozen confection in the cookie sandwich machine or other apparatus is generally through a tube 14 of an extruder. Means are typically employed to pump or push the confection through the extruder. At the end of the extruder is an orifice 16 through which the product exits the extruder. The orifice may be round, square, rectangular or some other shape.

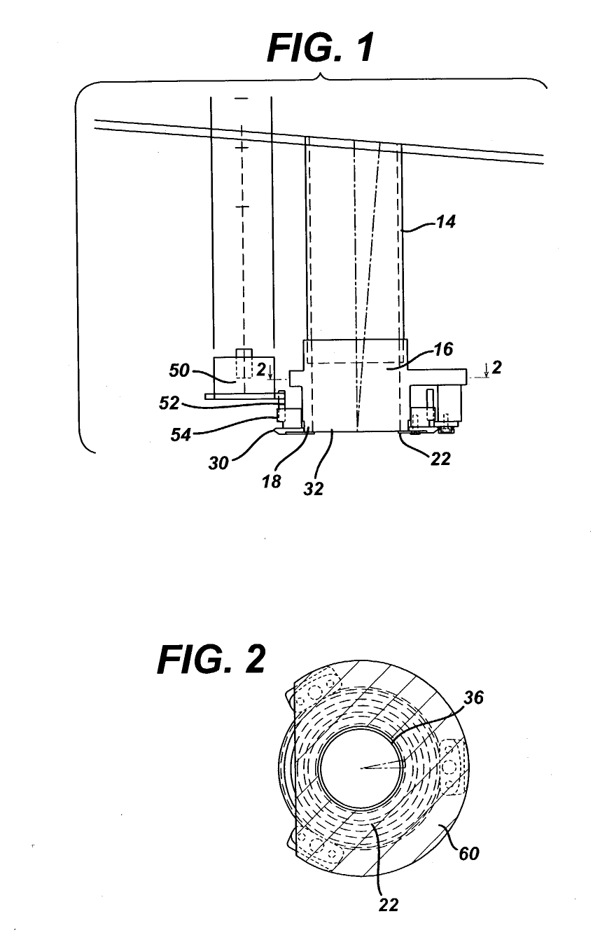

In accordance with one aspect of the invention, adapter housing 18 is fit onto the orifice-end of the extruder. The fit may be temporary or, preferably, it is permanent, as by welding. Adapter housing 18 illustrated in FIGS. 1, 3 and 8 includes sleeve 20 which fits snuggly around the outer circumference of the extruder. At the end of the adapter housing 18 opposite the end at which it is associated with the extruder, three (3) bearings 90 attached to the housing support a support ring 30. The support ring (30) in turn supports drive ring 54 above it. Interchangeable cutting disk 22 is fastened to support ring 30 and drive ring 54 by screws 92 which pass through attachment openings 38 of the disk 22.

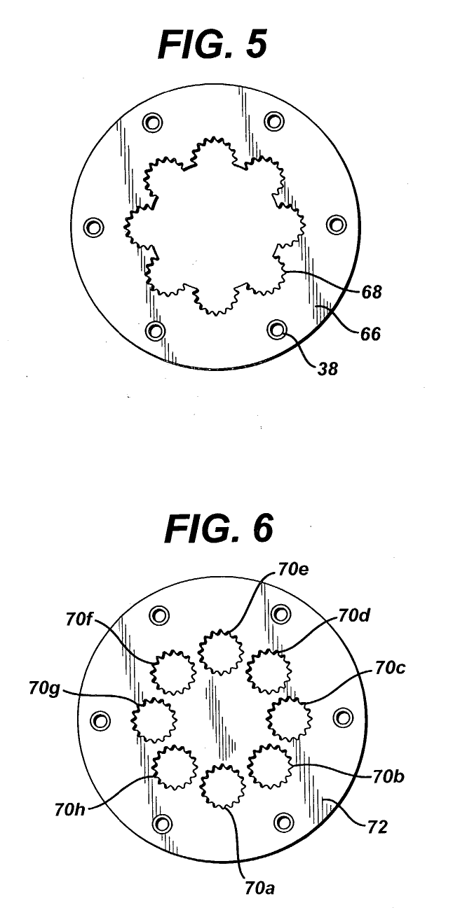

As seen particularly in FIG. 4, wherein cutting disks 22 having orifices of various shapes are shown, the disk includes a central orifice 36 and the peripheral attachment openings 38. Preferably, as shown, rings 22 include an uninterrupted periphery 40.

Often it will be advantageous for the orifice of the cutting disk to include a serious of regularly repeated notches with a predefined and precisely cut profile, as seen in the cutting disks of FIGS. 4a-f, 5, and 6. In FIG. 5, the orifice 68 of disk 66 has something of a snowflake shape. While often the disk will include a single orifice, it may be desirable to employ a plurality of orifices, e.g, orifices 70a-h as seen for disk 72 in FIG. 6.

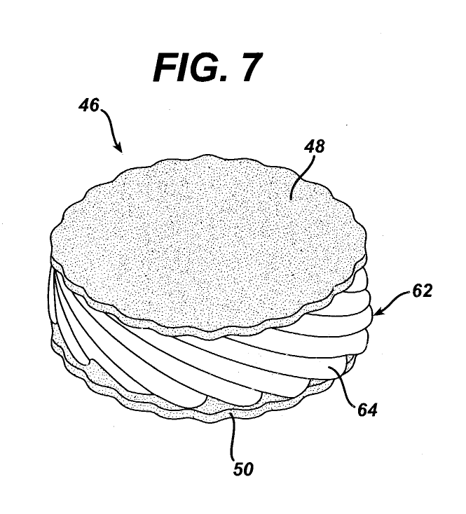

As will be apparent especially from FIGS. 4-6, various shapes for the central orifice of the disks are possible. It has been found that it is possible to impart various patterns to the dispensed viscous fluid, e.g., no or low fat ice-cream, depending on the arrangement of the centrally disposed orifice of the disks. In general, one disk will be used in the apparatus, although this will preferably be interchangeable with other disks. Preferably, the disks are rotated as the ice-cream is dispensed. In this way, the braided design shown at the periphery of low fat ice-cream sandwich 46 (see FIG. 7) can be obtained. Sandwich 46 comprises wafers 48 and 50 between which is disposed low fat ice-cream 62 which can be seen from the periphery to be divided into braids 64. In accordance with the invention, such braids can be created by machine through the use of the disks.

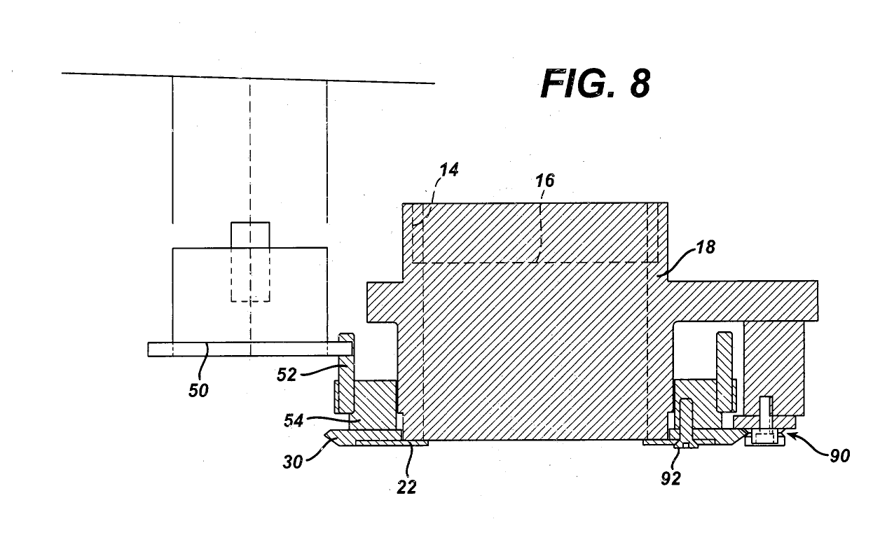

The movement preferably imparted to the disk during dispensing of the confection is preferably rotation. This can be effected by a motor which drives sprockets 50 which in turn engage pins 52 on drive ring 54 which is supported by support ring 30, to which is attached disk 22. The motor drives sprocket 50 which rotates and drives pins 52 which in turn causes the disk 22 to rotate. In FIG. 8, parts which rotate are hatched bottom right to top left, whereas stationary parts are hatched bottom left to top right.

In operation, ice-cream or other frozen confection is pumped through extruder 14 through extruder orifice 16 and then through orifice 36 of disk 22. While the frozen confection is being pumped through the extruder, disk 22 is preferably being rotated via the motor/sprocket/pins mechanism. The disk 22 has orifice 36 in one of the one configurations shown in FIGS. 4 through 6 or in another configuration as chosen by the operator.

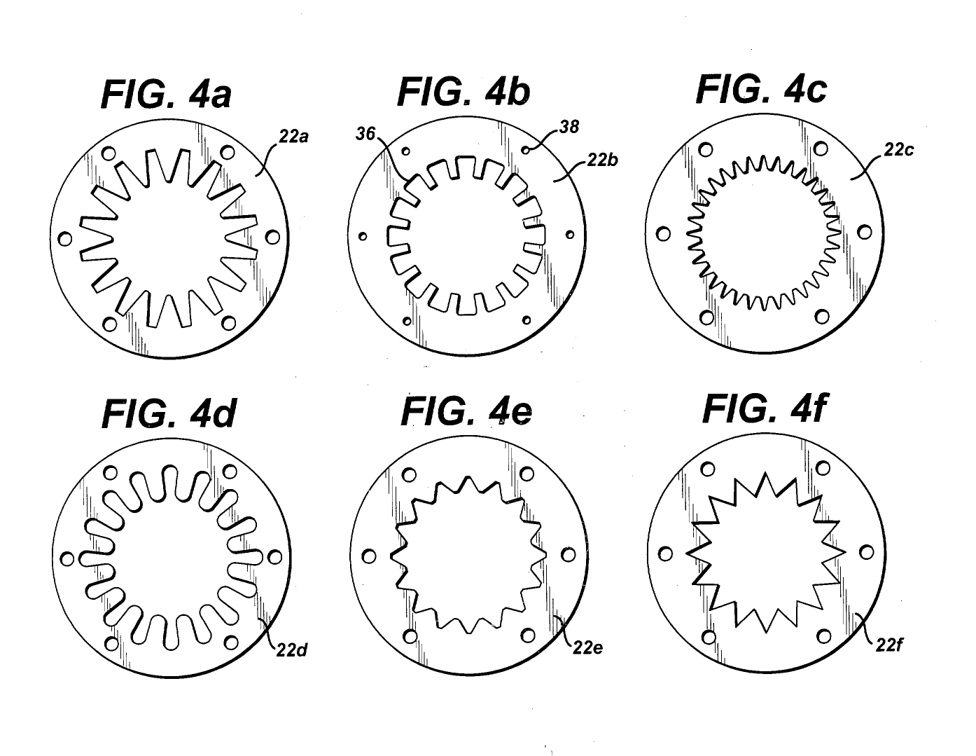

A pre-determined amount of frozen confection is pumped through orifice 36 and onto cookie wafer 50. Thereafter, second cookie wafer 48 is placed atop the frozen confection in a manner known in the art. The result is a braided pattern as seen in FIG. 7 along the periphery of the ice cream sandwich, or some other pattern as is chosen, e.g., by selecting another of the disks and/or by choosing movement parameters therefor. Instead of pumping a pre-determined amount of frozen confection each time, frozen confection may be pumped continuously and cut by a heated wire across a plane parallel to that of the cutting disk and slightly below. To facilitate cutting of the frozen confection, it may be desirable to incline the dispensing end of the extruder a few degrees away from the vertical, as seen in FIG. 3. In such case, of course, the adapter will also be so inclined since it fits on the inclined dispensing end of the extruder.

In addition to supporting the support ring, the bearings ensure that the interchangeable cutting disk 22 stays in close proximity to the mouth of the extruder and rotates in the preferred concentric pattern relative to the stationary part of the extruder and housing.

Most preferably, the cutting disk is flat and flush on the end; no projections should be permitted. The cutting wire, if used, should pass along the face of the cutting disk as closely as possible.

Preferably the motion imparted to the disk is a continuous one. Continuous in this context does not foreclose change in direction. Thus, for example, a forward and back motion (like windshield wipers) or speeding up and slowing down, on a rhythmic basis, one cycle per sandwich, could be employed. The result would be a wave pattern.

The apparatus, then, used in the invention to extrude the ice cream, low fat ice cream, no fat ice cream, other frozen confection or, indeed, other viscous liquid, essentially includes three pieces, a stationary piece including the extruder tube and the bearings, a drive unit (motor and sprocket) and a rotating piece which includes a support ring (supported on the bearings), a drive ring and the interchangeable disk attached to the support ring.

It will be appreciated that the invention provides an easy way to impart braiding or other designs to frozen confections by simple adaptation of existing technology. Indeed, it is believed that the invention can be used for other viscous liquids (liquid at processing temperature) such as butter, margarine and other spreads, hand creams, cream cheese, soaps and other detergent bars,

To avoid separation of fat, so called “buttering out” as a result of the shear experienced by the frozen confection during processing, the invention is most advantageously used on ice cream and other frozen confections having about 12 wt % fat or less. That is 0% fat, 0.5 wt % fat and up to about 12 wt % and ranges and levels of fat in between would preferably be utilized in the invention.

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. An adapter for imparting shape to a viscous liquid comprising:
a) an orifice modifier having an opening other than a circular shape, said adapter being suitable to secure to a viscous liquid dispenser in fluid communication with a viscous liquid dispensing opening.

2. The adapter according to claim 1 including structure adapted to secure the adapter to said viscous liquid dispenser in fluid communication with said viscous liquid dispensing opening.

3. The adapter according to claim 1 wherein said orifice modifier includes a disc.

4. The adapter according to claim 3 wherein said disc includes a centrally disposed opening and wherein at least 10% of the length of the circumference of the opening is not in the shape of an arc or arcs and wherein at least 10% of the length of the circumference of the opening is in the shape of an arc or arcs.

5. The adapter according to claim 4 wherein said disc includes a centrally disposed opening and wherein at least 60% of the length of the circumference of the opening is not in the shape of an arc or arcs.

6. The adapter according to claim 5 wherein said disc has an outer circumference which is uninterrupted.

7. The adapter according to claim 1 in combination with a mechanism adapted to move the orifice modifier while a viscous fluid is being dispensed through the modifier.

8. A viscous liquid dispensing apparatus comprising a dispensing orifice and a mechanism for moving said dispensing orifice while said viscous liquid is being dispensed so that a pattern is created in the viscous liquid.

9. A viscous liquid dispensing apparatus comprising a dispensing orifice, an orifice modifier in fluid communication with said orifice and a mechanism for moving said orifice modifier while said viscous liquid is being dispensed.

10. The apparatus according to claim 9 wherein said orifice modifier includes a disc.

11. The apparatus according to claim 9 wherein said disc includes a centrally disposed opening which is not of the same shape as the dispensing orifice of said liquid dispensing apparatus and wherein at least 10% of the length of the circumference of the opening is not in the shape of an arc or arcs.

12. The apparatus according to claim 11 wherein said disc includes a centrally disposed opening and wherein at least 60% of the length of the circumference of the opening is not in the shape of an arc or arcs.

13. The adapter according to claim 5 wherein said disc has an outer circumference which is uninterrupted.

14. A method of dispensing a viscous liquid comprising feeding said viscous liquid through an orifice and moving said orifice while feeding the liquid so as to create a pattern in the viscous liquid.

15. A method of dispensing a viscous liquid comprising feeding said viscous liquid through a first orifice, and through an orifice modifier having a different shaped orifice than said first orifice in fluid communication with said first orifice so as to create a pattern in the viscous liquid.

16. The method according to claim 15 further comprising moving said orifice modifier while said viscous liquid is fed through said orifice modifier so as to create the pattern.

17. An orifice modifier comprising a central opening and an uninterrupted periphery said central opening including projecting parts projecting into said opening.

18. The orifice modifier according to claim 17 in the form of a disk.

19. The adapter according to claim 1 wherein said orifice modifier is interchangeable with another orifice modifier.
